(19) United States
(12) Patent Application Publication
(10) Pub. No.: US 2024/0303485 A1
(43) Pub. Date: Sep. 12, 2024

(54) APPARATUS, METHOD, DEVICE AND MEDIUM FOR LOSS BALANCING IN MULTI-TASK LEARNING

(71) Applicant: Intel Corporation, Santa Clara, CA (US)

(72) Inventors: Wenjing KANG, Beijing (CN); Xiaochuan LUO, Beijing (CN); Xianchao XU, Beijing (CN)

(21) Appl. No.: 18/571,616

(22) PCT Filed: Dec. 2, 2021
(86) PCT No.: PCT/CN2021/135129

§ 371 Date: Dec. 18, 2023

(51) Int. Cl. G06N 3/08

(52) U.S. Cl. CPC G06N 3/08

(57) ABSTRACT

The disclosure provides an apparatus, method, device, and medium for loss balancing in MTL. The apparatus includes interface circuitry and processor circuitry. The processor circuitry is configured to initialize parameters of shared layers of a deep neural network for MTL using a pre-trained neural network; determine a custom interval consisting of a designated number of mini-batch training steps and a designated window of N custom intervals (N>2); for each task, calculate a loss change rate between each pair of N−1 pairs of neighboring custom intervals within a designated window prior to a present custom interval and a gradient magnitude with respect to selected shared weights within the designated window prior to the present custom interval, and adjust, a weight of the task, based on the calculated loss change rate and gradient magnitude with respect to selected shared weights.

### TECHNICAL FIELD

Embodiments of the present disclosure generally relate to techniques of multi-task learning, and in particular to an apparatus, method, device, and medium for loss balancing in multi-task learning (MTL).

### BACKGROUND ART

Deep multitask networks, in which a neural network produces multiple predictive outputs, can offer better speed and performance than their single-task counterparts, but are challenging to train properly. In multi-task learning (MTL), weighting scheme often plays an important role because it can balance joint learning of all tasks to prevent a one-sided training scenario where some tasks are dominant and overwhelm others.

### SUMMARY

According to an aspect of the disclosure, an apparatus for loss balancing in multi-task learning (MTL) is provided. The apparatus includes interface circuitry configured to receive a pre-trained neural network; and processor circuitry coupled to the interface circuitry. The processor circuitry is configured to: initialize parameters of shared layers of a deep neural network for MTL using the pre-trained neural network; determine a custom interval consisting of a designated number of mini-batch training steps and a designated window of N custom intervals, wherein N is an integer greater than 1; calculate, for each task, a loss change rate between each pair of N−1 pairs of neighboring custom intervals within a designated window prior to a present custom interval; calculate, for each task, a gradient magnitude with respect to selected shared weights within the designated window prior to the present custom interval; and adjust, for each task, a weight of the task, based on the loss change rate between each pair of the N−1 pairs of neighboring custom intervals within the designated window prior to the present custom interval for the task, and the gradient magnitude with respect to selected shared weights within the designated window prior to the present custom interval for each task.

According to another aspect of the disclosure, a method for loss balancing in multi-task learning (MTL) is provided. The method includes: initializing parameters of shared layers of a deep neural network for MTL using a pre-trained neural network; determining a custom interval consisting of a designated number of mini-batch training steps and a designated window of N custom intervals, wherein Nis an integer greater than 1; calculating, for each task, a loss change rate between each pair of N−1 pairs of neighboring custom intervals within a designated window prior to a present custom interval; calculating, for each task, a gradient magnitude with respect to selected shared weights within the designated window prior to the present custom interval; and adjusting, for each task, a weight of the task, based on the loss change rate between each pair of the N−1 pairs of neighboring custom intervals within the designated window prior to the present custom interval for the task, and the gradient magnitude with respect to selected shared weights within the designated window prior to the present custom interval for each task.

Another aspect of the disclosure provides a device including means for implementing the method of the disclosure.

Another aspect of the disclosure provides a machine readable storage medium having instructions stored thereon, which when executed by a machine cause the machine to perform the method of the disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the document.

FIG. 1 shows a flow chart showing a process for loss balancing in MTL using the GNA weighting scheme in accordance with some embodiments of the disclosure

FIG. 2 shows an illustrative diagram of a decaying coefficient α, for a loss change rate between (t−n)^{th} interval and (t−(n+1))^{th} interval, where t denotes the present custom interval, in accordance with some embodiments of the disclosure.

FIG. 3 shows a schematic diagram of applying a Gradient Norm Average (GNA) weighting scheme in a scenario where MTL is combined with a PLM in accordance with some embodiments of the disclosure.

FIG. 4 is a graph showing a task-specific weight curve with respect to training steps of a Gradient Normalization (Gradnorm) weighting scheme.

FIG. 5 is a graph showing a task-specific weight curve with respect to training steps of a Dynamic Weight Average (DWA) weighting scheme.

FIG. 6 is a graph showing a task-specific weight curve with respect to training steps of the GNA weighting scheme.

FIG. 7 is a block diagram illustrating components, according to some example embodiments, able to read instructions from a machine-readable or computer-readable medium and perform any one or more of the methodologies discussed herein.

FIG. 8 is a block diagram of an example processor platform in accordance with some embodiments of the disclosure.

### DETAILED DESCRIPTION OF EMBODIMENTS

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

MTL uses a single neural network to perform several related tasks by learning shared representations from multi-task supervisory signals. MTL can be more efficient than using single-task networks for the following reasons: memory cost will be greatly reduced due to layer sharing; an inference speed can be increased due to bypassing multiple forward passes through single task networks; and a performance of MTL is promising when the related tasks share complementary knowledge which can benefit each other.

In practice, a optimization objective of an MTL problem is often formulated as a linear combination of per task loss:

$${L}_{MTL} = {\sum }_{i = 1}^{K} {w}_{i} {L}_{i} \qquad ( 1 )$$

where K denotes a total number of tasks, i=1, . . . , K denotes a task index, Lᵢ denotes a loss function of task i, wᵢ denotes a weight of task i, and L_{MTL} denotes a total loss of the MTL problem.

Traditionally, a stochastic gradient is used to solve the above optimization objective. In this case, updating (W_{shared}:) of parameters (i.e. weights) of shared layers (W_{shared}) is defined as:

$${W}_{shared} := {W}_{shared} - η {\sum }_{i = 1}^{K} \frac{\partial {w}_{i} {L}_{i}}{\partial {W}_{shared}} \qquad ( 2 )$$

where η denotes a learning rate,

$$\frac{\partial {w}_{i} {L}_{i}}{\partial {W}_{shared}}$$

denotes a gradient of wᵢLᵢ with respect to W_{shared}.

As can be seen from Equation (2), the gradient of wᵢLᵢ with respect to W_{shared} has a direct impact on the updating of weights of shared layers. Network parameters updating may be suboptimal when the task gradients are dominated by one task whose gradient magnitude is much larger than the other tasks. The one-sided training scenario where some disadvantaged tasks are completely overwhelmed by dominant ones can be avoided by manipulating the task-specific weights wᵢ in the loss.

Currently, two representative weighting schemes are Gradient Normalization (Gradnorm) proposed by Chen, Zhao, et al. in 2018 and Dynamic Weight Average (DWA) proposed by Liu, Shikun et al. in 2019.

Gradnorm was proposed to balance multi-task network training by manipulating task-specific gradients with respect of parameters of shared layers to have similar magnitude. In this way, the multi-task network is spurred to learn all tasks at an even pace. To achieve this goal, an extra computation graph is built to calculate a discrepancy between a gradient norm of the weighted task loss (i.e., wᵢLᵢ) with respect to the chosen weights W and an average gradient norm across all tasks multiplied by task-specific relative inverse training rate. A stochastic gradient descent is used to solve this Gradnorm objective by updating task-specific weights wᵢ. However, empirically, the resulting task weights curve indicates that as the training goes on, the task weights often move in a certain direction. As training enters the mid-late phase, some tasks become dominant while others are suppressed, which is undesired.

DWA adapts task weighting over time by considering a change rate of average loss for each task. In an original implementation of DWA, an average loss value is calculated as an average loss of each epoch to reduce the uncertainty from stochastic gradient descent. However, the epoch-level average loss is not suitable for fine-tuning on downstream tasks with pre-trained models, because a task weight update frequency in this case is inherently low. At the same time, when based on pre-trained models, the fine-tuning process in downstream tasks converges much faster than training from scratch, so updating the task weight with average loss of an epoch will fall behind the fine-tuning process with a fast training pace. In terms of a multi-task fine-tuning scenario based on pre-trained models, a finer-grained task weights updating strategy is more applicable. Moreover, in DWA, task-specific weights are only based on the change rate of each task's loss, without considering an aspect of gradient magnitude, so some tasks could still overwhelm others during training. DWA requires only a numerical task loss, and therefore its implementation is simpler compared to Gradnorm.

Table 1 shows pros and cons of the weighting schemes Gradnorm and DWA.

TABLE 1

| Weight | | |
|---|---|---|
| scheme | Pros | Cons |
| Gradnorm | Both the gradient | At the mid-late training stage, |
| | magnitude and loss | some tasks dominate while |
| | change rate are | others are suppressed. |
| | considered. | |
| DWA | Its implementation | Only the loss change rate is |
| | is simple. | considered, while the gradient |
| | | magnitude is not considered. It is |
| | | based on an average loss in epoch |
| | | level, and is thus coarse-grained. |

In order to overcome some of the drawbacks of the present weighting schemes, the present application proposes a gradient norm average (GNA) weighting scheme, which takes both a loss change rate and a gradient magnitude into account and updates task weights at a fine-grained level.

According to the GNA weighting scheme, weights will change along with both the loss change rate and gradient magnitude during an early training phase, whereas during a mid-late training phase, tasks will be trained in an alternate manner rather than the scenario in Gradnorm where the dominant task overwhelms the suppressed ones. Besides, the GNA weighting scheme updates task weights at a fine-grained level, so as to keep up with quick converging when downstream tasks are fine-tuned based on pre-trained models.

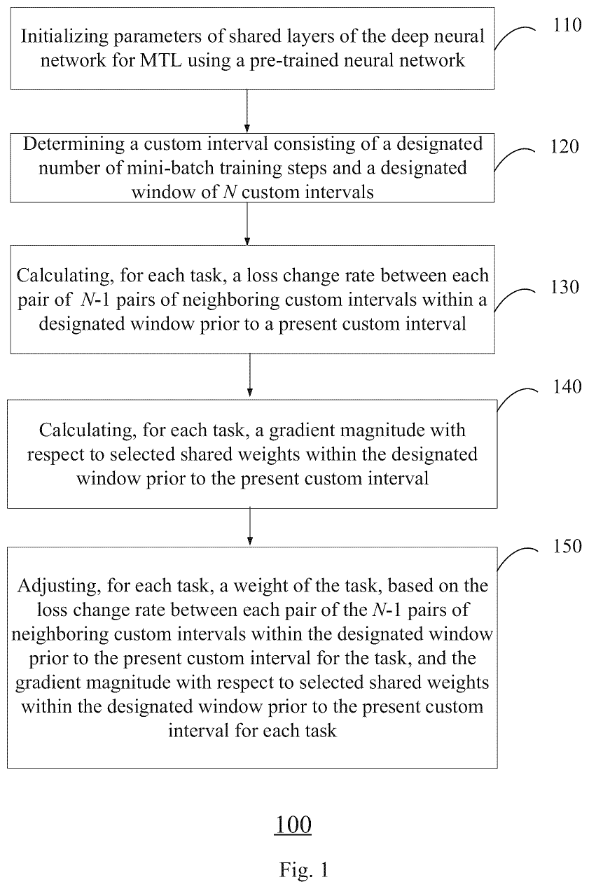

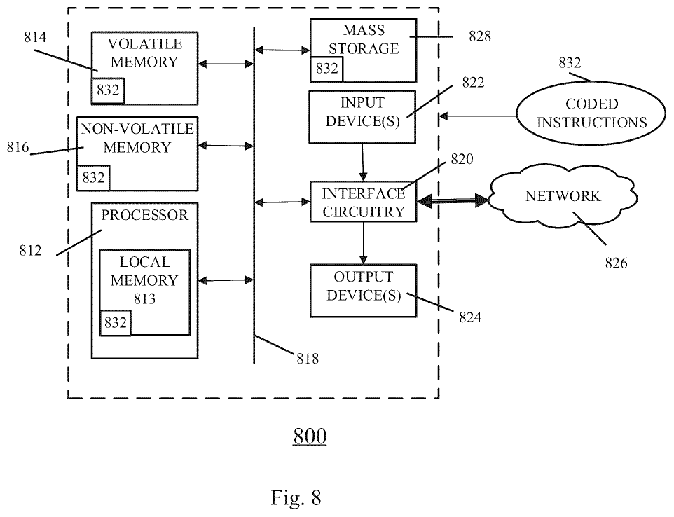

FIG. 1 shows a flow chart showing a process 100 for loss balancing in MTL using the GNA weighting scheme in accordance with some embodiments of the disclosure. The process 100 may be implemented, for example, by one or more processors of a deep neural network for MTL. An example of the processors is to be shown in FIG. 8.

The process 100 may include, at block 110, initializing parameters of shared layers of the deep neural network for MTL using a pre-trained neural network. The parameters of shared layers may include, for example, shared weights. The pre-trained neural network may include pre-trained models for computer vision (CV), natural language understanding (NLU), or vision and language learning. Correspondingly, the deep neural network for MTL may be a deep neural network for computer vision and a deep neural network for NLU.

The process 100 may include, at block 120, determining a custom interval consisting of a designated number of mini-batch training steps and a designated window of N custom intervals.

As mentioned above, DWA updates tasks' weights based on an average loss change rate of two neighboring epochs, which is rather coarse-grained. Instead of leveraging the average loss in an epoch level, the GNA weighting scheme defines a custom interval, which consists of a designated number of mini-batch training steps, such as 20, 50, or more mini-batch training steps. The less mini-batch training steps included in a custom interval, the finer the grain, in the cost of larger computational overhead.

The GNA weighting scheme further introduces a hyperparameter window size N, i.e., a designated window would include N custom intervals. Nis an integer greater than 1, such as 2, 4, 5 and the like. Therefore, a window includes N−1 pairs of custom intervals. In order to ease the uncertainty from mini-batch stochastic gradient descent, a loss change rate between each pair of the N−1 pairs of neighboring custom intervals is considered.

The process 100 may then include, at block 130, calculating, for each task, a loss change rate between each pair of N−1 pairs of neighboring custom intervals within a designated window prior to a present custom interval.

In some embodiments, in order to adjust the loss change rate, a decaying coefficient αₙ for the loss change rate is defined under following rules:
for each task, a sum of decaying coefficients corresponding to loss change rates of the N−1 pairs of neighboring custom intervals within the designated window prior to the present custom interval should equal one; and
a decaying coefficient should be greater when a corresponding pair of neighboring custom intervals is closer to the present custom interval.

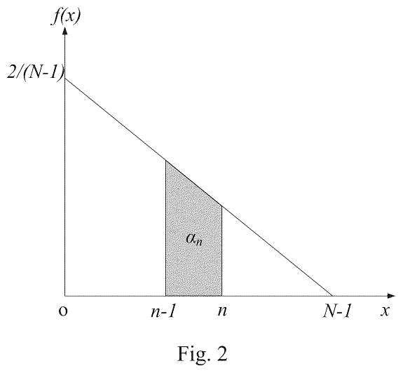

Just an example, FIG. 2 shows an illustrative diagram of a decaying coefficient αₙ for a loss change rate between (t−n)^{th} interval and (t−(n+1))^{th} interval, where t denotes the present custom interval, in accordance with some embodiments of the disclosure.

As shown in FIG. 2, the decaying coefficient αₙ between (t−n)^{th} interval and (t−(n+1))^{th} interval is modeled as an integral of a probability density function ƒ(x):

$${α}_{n} = {\int }_{n - 1}^{n} f ( x ) dx , n = 1 , … , N - 1. \qquad ( 3 )$$

In this example, ƒ(x) and its primitive function F(x) are defined as:

$$f ( x ) = - \frac{2}{{( N - 1 )}^{2}} x + \frac{2}{N - 1} , 0 \leq x \leq N - 1 ; \qquad ( 4 )$$

$$F ( x ) = - \frac{1}{{( N - 1 )}^{2}} {x}^{2} + \frac{2}{N - 1} x .$$

As shown in FIG. 2, as time goes on, the more recent interval pair has a greater decaying coefficient, while the earlier ones have a smaller decaying coefficient, since the more recent interval pair can better represent the current loss change rate.

In other examples, ƒ(x) can have various expressions, as long as the above-mentioned two rules are met.

Another drawback of DWA is that it only considers the loss change rate but does not consider the gradient magnitude. The GNA weighting scheme, as proposed, takes both the loss change rate and gradient magnitude into account.

The process 100 may then include, at block 140, calculating, for each task, a gradient magnitude with respect to selected shared weights within the designated window prior to the present custom interval.

In some embodiments, the selected shared weights may include weights of a last (i.e. highest) shared layer of the deep neural network, in order to save compute costs and select a group of parameters which are applicable to task-level representation learning.

In some embodiments, a gradient magnitude with respect to selected shared weights may be expressed by a Euclidean norm (i.e., L₂ norm) of a gradient of a weighted task-specific loss with respect to the selected shared weights.

The process 100 may then include, at block 150, adjusting, for each task, a weight of the task, based on the loss change rate between each pair of the N−1 pairs of neighboring custom intervals within the designated window prior to the present custom interval for the task, and the gradient magnitude with respect to selected shared weights within the designated window prior to the present custom interval for each task.

In an embodiment, the GNA weighting scheme can adjust a weight of a particular task according to an equation (5) below:

$${w}_{k} ( t ) := \frac{K exp ( {λ}_{k} ( t - 1 ) / T )}{{\sum }_{i = 1}^{K} exp ( {λ}_{i} ( t - 1 ) / T )} \qquad ( 5 )$$

where K denotes a total number of tasks, k=1, . . . , K denotes k^{th} task, wₖ (·) denotes a weight of k^{th} task, and t denotes the present custom interval.

In equation (5), T is a scaling factor to control softness of task weighting. A greater value for T produces a softer probability distribution over classes. That is to say, a larger T results in a more even weight distribution among tasks. A softmax operation multiplied K guarantees that Σᵢ₌₁^{k}wₖ(t)=K.

As shown in equation (5), wₖ(t) is adjusted mainly by λₖ(t−1). λₖ(·) is then defined as an adjustment factor. As an example, a particular expression of λₖ(·) is given by an equation (6) below

$${λ}_{k} ( t - 1 ) = ( {\sum }_{j = 1}^{N - 1} {α}_{j} * \frac{{L}_{k} ( t - j )}{{L}_{k} ( t - j - 1 )} ) * {( log \frac{{\sum }_{i = 1}^{K} {\sum }_{j = 1}^{N} {G}_{i} ( t - j )}{{\sum }_{j = 1}^{N} {G}_{k} ( t - j )} )}^{scale\_exp} . \qquad ( 6 )$$

In equation (6), aⱼ denotes the decaying coefficient between (t−j)^{th} custom interval and (t−j−1))^{th} custom interval and Σⱼ₌₁^{N-1}aⱼ=1 (j=1, . . . , N−1). In some embodiments, aⱼ may be the decaying coefficient discussed with reference to FIG. 2

In equation (6), Lₖ(·) denotes an average loss in a custom interval of k^{th} task, and thus

$$\frac{{L}_{k} ( t - j )}{{L}_{k} ( t - j - 1 )}$$

denotes a loss change rate between (t−j)^{th} custom interval and (t−j−1))^{th} custom interval as calculated in block 130 for k^{th} task, and thus

$${\sum }_{j = 1}^{N - 1} {α}_{j} * \frac{{L}_{k} ( t - j )}{{L}_{k} ( t - j - 1 )}$$

denotes a weighted sum of loss change rates of N−1 pairs of neighboring intervals within the designated window prior to the present custom interval t for k^{th} task.

In equation (6), Gₖ(·) denotes a gradient magnitude with respect to the selected shared weights of k^{th} task, thus Σ=ⱼ₌₁^{N}Gₖ(t−j) denotes a gradient magnitude with respect to selected shared weights within the designated window prior to the present custom interval t, as calculated in block 130 for k^{th} task, and Σᵢ₌₁^{K}Σⱼ₌₁^{N}Gᵢ(t−j) denotes a total of gradient magnitudes with respect to selected shared weights of the K tasks. As shown in equation (6), λₖ(·) considers a reciprocal of proportion of a task-specific gradient magnitude with respect to selected shared weights in the designated window prior to the present custom interval to gradient magnitudes with respect to selected shared weights within the designated window prior to the present custom interval for all tasks.

In equation (6), scale_exp is a scaling factor to control importance of each gradient magnitude to accommodate for various priors between tasks. A greater value for scale_exp indictaes a greater impact of a corresponding gradient magnitude.

During each mini-batch training step, a task loss and a task gradient with respect to selected shared weights are recorded for each task, to constitute statistics for a custom interval, which includes a designated number of mini-batch training steps. A loss and a gradient magnitude with respect to selected shared weights within a custom interval for each task are an average of task losses and task gradients with respect to selected shared weights for the task recorded during the designated number of mini-batch training steps within the custom interval. After accumulating custom intervals of a window size N, weights of all the tasks can be updated for a first time.

The reciprocal of the proportion of each task average gradient magnitude in the gradient magnitudes of all the tasks in the N custom intervals will further penalize those tasks which learn faster and have larger gradient magnitudes.

More particularly, the process 100 of FIG. 1 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the process 100 of FIG. 1 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

The novel weighting scheme for loss balancing in MTL (i.e., the GNA weighting scheme) can be applied to various deep learning multi-task scenarios, such as multi-task learning in computer vision or multi-task vision and language learning, for example, multi-task learning using pre-trained language models (PLMs). The GNA weighting scheme would have a great prospect in current popular multi-task learning architectures, such as the Multi-Task Deep Neural Networks for Natural Language Understanding (MTDNN) of Microsoft®, Multitask ViLBERT (Vision and Language (ViL) Bidirectional Encoder Representations from Transformers (BERT)) of Facebook®, JointBERT of Alibaba®, and so forth.

As an example, a particular implementation is described, where the novel weighting scheme for loss balancing in MTL (i.e., the GNA weighting scheme) is combined with pre-trained language models (PLMs) to improve a performance in Natural Language Understanding (NLU). On one hand, with MTL and PLMs combined, training objective often converges much faster than training from scratch. Therefore, a fine-grained weighting scheme is needed. On the other hand, existing weighting schemes either do not consider gradient magnitude or cannot avoid one-sided training scenario. Empirical results on a joint intent classification and slot filling task and weights curve demonstrates its ability in handling MTL in NLU tasks with PLMs.

Plenty of work has demonstrated that PLMs such as Vision and Language (ViL) Bidirectional Encoder Representations from Transformers (BERT) are effective for learning universal text representations by exploiting large corpora, which benefits downstream natural language understanding (NLU) tasks. The MTL and NLU tasks can be combined to enhance text representation learning to improve the performance of the NLU tasks. For example, MTDNN tries to incorporate BERT as the shared layers across tasks and top task-specific layers in an MTL context with pre-trained language models, which has achieved superior results in several NLU tasks such as single-sentence classification, pairwise text classification, etc.

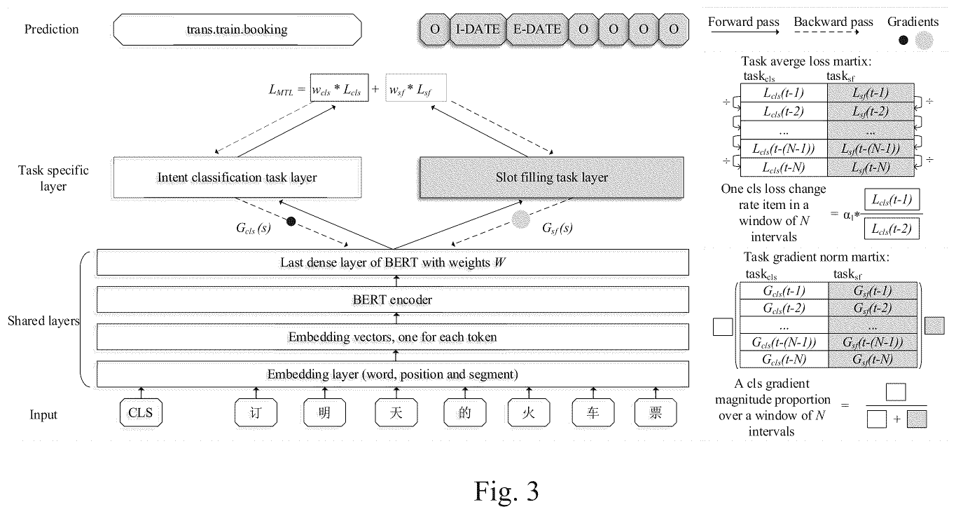

FIG. 3 shows a schematic diagram of applying the GNA weighting scheme in a scenario where MTL is combined with a PLM in accordance with some embodiments of the disclosure.

There are two pivotal tasks for constructing an NLU system, i.e., intent classification (abbreviated as “cls”) and slot filling (abbreviated as “sf”). The intent classification task aims to identify users' intents, and the slot filling task aims to extract semantic constituents from the natural language utterances.

In FIG. 3, the well-known pre-trained language model BERT is selected as the fundamental PLM. Two specific layers are added on the top of BERT, namely an intent classification layer and a slot filling layer. To be more concrete, the BERT's CLS output contextual embedding is fed into a linear layer for intent classification, and the rest tokens' contextual embeddings are fed into a linear layer for slot filling. A cross entropy loss is used as a loss function of the intent classification task (L_{cls}) and a conditional random field (CRF) loss is used as a loss function of the slot filling task (L_{sf}).

The GNA weighting scheme involves a selection of shared layers parameters for calculating gradient magnitudes. On one hand, an earlier study has indicated that BERT captures a rich hierarchy of linguistic information. Lower layers tend to concentrate on local information such as syntactic aspects, while the higher layers focus on global phenomena such as semantic features which are task specific. So, parameters (i.e. weights) of the higher layers are more task specific than the lower layers. On the other hand, selecting more weights will incur more compute costs. To save compute costs and to select a group of parameters which are applicable to task-level representation learning, weights of the last (i.e. highest) dense layer of the shared BERT encoder are selected as shared weights W.

The BERT-base-Chinese PLM is used to initialize the shared BERT layers. Training epochs is set to 7. Batch size is set to 32. Maximum sequence length is set to 50. Window size N is set to 4 and each custom interval consists of 50 training steps. Dropout is applied for the two task specific layers, namely the intent classification layer and slot filling layer, and a dropout rate is set to 0.3 and 0.2, respectively. AdamW is selected as an optimizer with an adam_epsilon of 1e-8. A model learning rate is set to 1e-5.

In FIG. 3, Gₖ(s) denotes a k^{th} task's gradient magnitude with respect to selected shared weights W during each training step s. For example, G_{cls}(s) denotes a gradient magnitude with respect to selected shared weights W during each training step s of the intent classification task (cls) and G_{sf}(s) denotes a gradient magnitude with respect to selected shared weights W during each training step s of the slot filling task (sf).

In FIG. 3, Lₖ denotes a k^{th} task's loss, i.e., L_{cls} denotes a loss of the intent classification task (cls) and L_{sf} denotes a loss of the slot filling task (sf). L_{MTL} denotes a total loss of the MTL, L_{MTL}=w_{cls}*L_{cls}+w_{sf}*L_{sf}, where was denotes a weight corresponding to L_{cls} and w_{sf} denotes a weight corresponding to L_{sf}.

In a forward pass, a query is inputted. Just as an example, the query is “ [symbol] [symbol] ” in Chinese, which means “Book a train ticket tomorrow” in English. The query is from an internal dataset for the joint intent classification and slot filling task. For example, the internal dataset may include 55 intent types and 79 entity types. Training, development, and test sets may include 120,680 and 3,415 and 20,472 utterances, respectively.

Table 2 shows information of the query “ [symbol] ”.

TABLE 2
Query:

[symbol]

| | |
|---|---|
| labels | Intent: trans.train.booking |
| | Slots: O I-DATE E-DATE O O O O |

As an output of the forward pass, a prediction of the intent classification task is “trans.train.booking”, and a prediction of the slot filling task is “O I-DATE E-DATE O O O O”.

As mentioned, uneven gradient magnitudes across tasks cause one-sided training within a multi-task network with a pre-trained model, which is disadvantageous to general text representation learning. The proposed GNA weighting scheme considers both the loss change rate and gradient magnitude.

In a backward pass for each task, in order to alleviate the one-sided training issue, during each training step s, both a task loss and a task gradient with respect to selected shared weights W are recorded to calculate an average task loss and an average gradient magnitude with respect to selected shared weights W of a custom interval which consists of a designated number of training steps (such as, 50 training steps), respectively. Subsequently, each task's weighted loss change rate and a proportion of the gradient magnitude with respect to selected shared weights Win a custom interval can be obtained to calculate the final task weights wᵢ in Equation (5).

The intent classification accuracy and slots F1 are used as performance metrics of the models for intent classification and slot filling, respectively. In order to evaluate joint performance of the models, a semantic accuracy reporting accuracy in recognizing both the intent and all the slots is further adopted, which is given in Equation (7) below:

$$semantic accuracy = \frac{1}{P} {\sum }_{i = 1}^{P} {r}_{int} {r}_{slots} \qquad ( 7 )$$

where P is a sample number of development set's population; rᵢₙₜ denotes whether a recognition result of an intent type for one sample is correct (if correct, rᵢₙₜ=1; otherwise, rᵢₙₜ=0), and rₛₗₒₜₛ denotes whether the model has successfully recognized all slots (if successfully, rₛₗₒₜₛ=1; otherwise, rₛₗₒₜₛ=0).

To evaluate the effectiveness of the proposed GNA weighting scheme in MTL, as in FIG. 3, a joint model of the intent classification task and slot filling task is chosen as the training target.

The model has been trained on the training set of the internal dataset with three different weighting schemes, namely Gradnorm, DWA and GNA. Best performance statistics of three schemes on test set of the internal dataset is illustrated in Table 3.

To be consistent with the original implementation of DWA, a number of training steps in a custom interval for DWA is set to 3771, because 3771 is the number of training steps of each epoch ([120,680/32]=3771). Tuning the scale_exp and the number of training steps in a custom interval leads to performance gains. On this internal dataset for joint intent classification and slot filling task, the hyper-parameters which help to obtain the best statistics are also listed in the last column in Table 3 below. In GNA, a minimum threshold weight is assigned to a task whose resulting wₖ is less than the threshold.

TABLE 3

| | Evaluation Criteria | | | |
|---|---|---|---|---|
| Weighting | Intent | | Semantic | |
| Scheme | Accuracy | Slots F1 | Accuracy | Hyper-Parameters |
| Gradnorm | 88.81% | 86.99% | 78.53% | Alpha: 1.0 |
| | | | | Gradnorm Learning |
| | | | | Rate: 1e−4 |
| | | | | Sampling/Updating |
| | | | | Steps: 5 |
| | | | | Training Epochs: 7 |
| DWA | 88.38% | 86.22% | 78.60% | Interval Steps: 3771 |
| | | | | T: 2.0 |
| | | | | Training Epochs: 7 |
| GNA | [symbol] | [symbol] | [symbol] | Interval Steps: 50 |
| | | | | T: 2.0 |
| | | | | Window Size: 4 |
| | | | | Scale_exp: 0.2 |
| | | | | Training Epochs: 7 |
| | | | | Minimum Threshold: 0.1 |

As can be seen from Table 3, three metrics including an overall metric semantic accuracy, intent classification accuracy, slot filling F1 score are used to evaluate the performance of each of the Gradnorm, the DWA and the GNA weighting scheme. On all the three metrics, the novel weighting scheme GNA as proposed herein outperforms the Gradnorm and DWA weighting schemes. For the Gradnorm weighting scheme, its overall results are better than DWA weighting scheme but not as good as the GNA weighting scheme. This is caused by one-sided training at the mid-late stage. Such one-sided training will impede MTL model from learning general text representations and thus affect the final performance results. The DWA weighting scheme is updated with a rather low frequency, and thus its performance is generally worse than the Gradnorm and GNA weighting schemes.

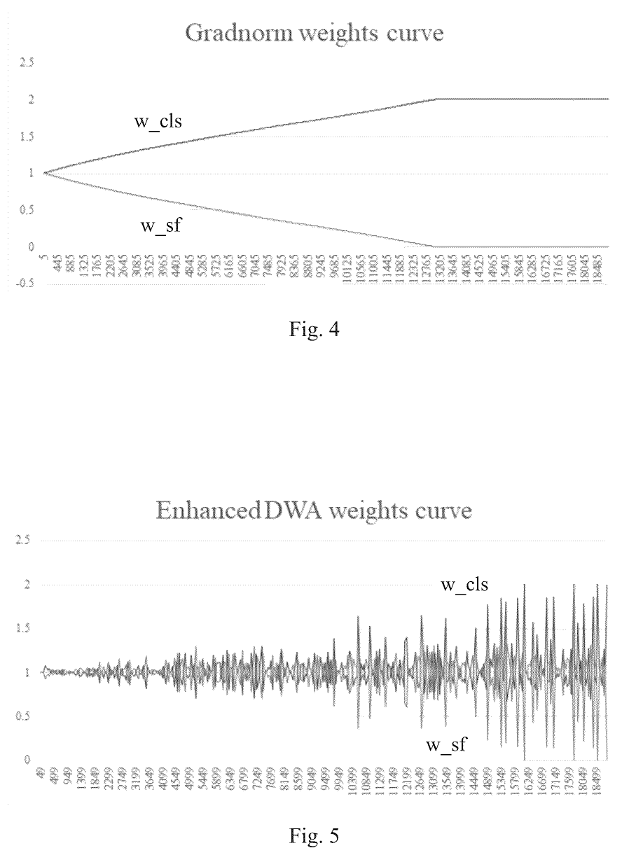

In order to show the improvements of the GNA weighting scheme over the Gradnorm and DWA weighting schemes more intuitively, FIG. 4-FIG. 6 are graphs showing task-specific weight curves with respect to training steps of the Gradnorm, DWA and GNA weighting schemes, respectively. In FIG. 4-FIG. 6, w_cls denotes a weight for the intent classification task and w_sf denotes a weight for the slot filling task. In all the experiments, models are trained for 7 epochs.

For Gradnorm, a sampling (i.e. weight updating) rate is set to 5 training steps, a loss learning rate is set to 1e-4, and Alpha is set to 1.0. To prevent task weights in Gradnorm from becoming negative, a minimum threshold 0 is set. As shown in FIG. 4, for Gradnorm, at the early training stage, each task's weight moves steadily towards two different directions, but in the mid-late stage some task becomes too dominant (the weight for the intent classification task reaches 2). Such a one-sided training is not applicable for reaching an optimal solution.

For DWA, its weights updating strategy is too coarse-grained as it is based on an average loss per epoch. To further observe the weights curve of DWA, the original DWA in epoch level is adapted to an enhanced fine-grained DWA in custom interval level. For this enhanced version of DWA, T is set to 2, a custom interval consists of 50 training steps and window size is set to default 2 as in the original implementation. As shown in FIG. 5, for the enhanced DWA, at the early training state, the loss change rates of the two tasks are similar, and thus the weights of the two tasks are fluctuating around 1.0 and close to each other; but at the mid-late stage, due to the existence of some batches difficult to learn, the occasional fluctuation amplitude becomes larger. Overall, there is no apparent trend of weights but stochasticity throughout. Such a weight scheme is also not beneficial for the MTL training

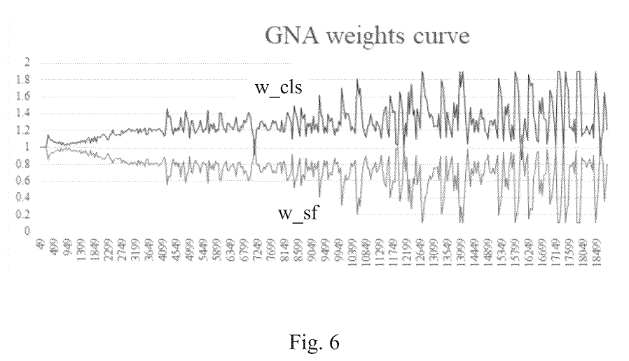

For GNA as proposed, T is set to 2 and a custom interval consists of 50 training steps, the Window size is set to 4 and scale_exp is set to 0.2. As shown in FIG. 6, for GNA, there is a more explicit trend for the weights at the early training stage than enhanced DWA, while at the mid-late stage the tasks are trained alternately rather than the one-sided scenario in Gradnorm. Therefore, such a weighting scheme is promising in balancing multi-task training.

Moreover, a Spearman correlation between the weight for the intent classification task (i.e., w_cls) and a time step for each of the Gradnorm, enhanced DWA and GNA weighting schemes are shown in Table 4 below. The Spearman correlation assesses how well the relationship between two variables can be described using a monotonic function. A Spearman correlation of zero indicates that there is no tendency for task weight to either increase or decrease when the time step increases. A Spearman correlation of +1 or −1 denotes each of the variables is a perfect monotone function of the other.

TABLE 4

| Weight scheme | Gradnorm | Enhanced DWA | GNA |
|---|---|---|---|
| Spearman correlation | 0.969 | −0.00379 | 0.454 |
| between w_cls and time step | | | |

As shown in Table 4, for Gradnorm, the Spearman correlation between the weight for w_cls and the time step is close to 1, which corresponds to that each task's weight moves steadily towards two different directions at the early training stage in FIG. 4.

For the enhanced DWA, the Spearman correlation between the weight for w_cls and the time step is close to 0. That is to say, there is no apparent trend of weights but stochasticity throughout.

For GNA as proposed, the Spearman correlation between the weight for w_cls and the time step is 10.454|, which is much larger than |−0.00379| of the enhanced DWA. That is to say, there is a more explicit trend for the weight at the early training stage for GNA than enhanced DWA.

According to embodiments of the disclosure, the GNA weighting scheme is a fine-grained task-specific weighting scheme, which is suitable for the MTL and PLM combination scenario. The GNA weighting scheme takes both loss change rate and gradient magnitude into account. It has also proven its potential in handling MTL NLU tasks with superior empirical results on the joint intent classification and slot filling task.

The GNA weighting scheme, as a universal approach, can be applied to many multi-task learning scenarios, e.g., multi-task learning in computer vision, multi-task learning in natural language understanding or multi-task vision+language learning. In a word, as long as it is a multi-task scenario that deals with fine-tuning multiple downstream tasks with multiple training objectives with a shared pre-trained model, the apparatus, method, device and computer readable storage medium for loss balancing in MTL using the GNA weighting scheme according to embodiments of the disclosure can be applied to it.

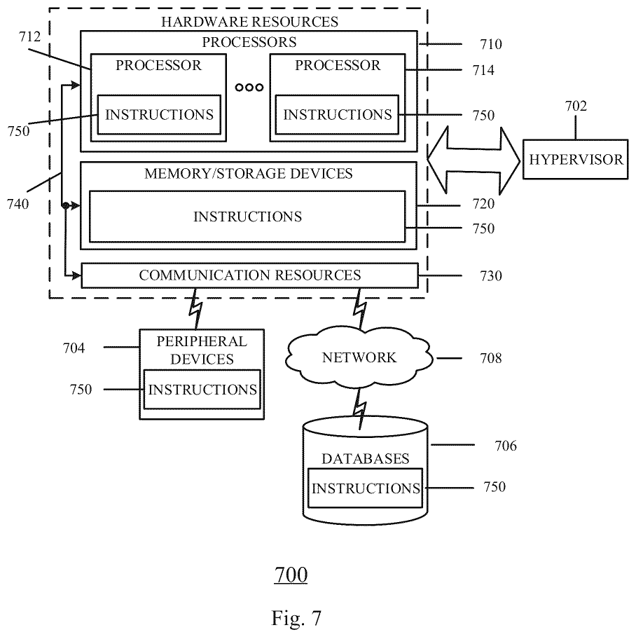

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714 which may be, e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof.

The memory/storage devices 720 may include main memory, disk storage, or any suitable combination thereof. The memory/storage devices 720 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 730 may include interconnection or network interface components or other suitable devices to communicate with one or more peripheral devices 704 or one or more databases 706 via a network 708. For example, the communication resources 730 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

FIG. 8 is a block diagram of an example processor platform in accordance with some embodiments of the disclosure. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes interface circuitry 820. The interface circuitry 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuitry 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 820 of the illustrated example, thus, typically includes a graphics driver card, a graphics driver chip and/or a graphics driver processor.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 820 may include a training dataset inputted through the input device(s) 822 or retrieved from the network 826.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

Machine executable instructions 832 may be stored in the mass storage device 828, in the volatile memory 814, in the non-volatile memory 816, and/or on a removable non-transitory computer readable storage medium such as a CD or DVD.

The following paragraphs describe examples of various embodiments.

Example 1 includes an apparatus for loss balancing in multi-task learning (MTL), comprising: interface circuitry configured to receive a pre-trained neural network; and processor circuitry coupled to the interface circuitry and configured to: initialize parameters of shared layers of a deep neural network for MTL using the pre-trained neural network; determine a custom interval consisting of a designated number of mini-batch training steps and a designated window of N custom intervals, wherein N is an integer greater than 1; calculate, for each task, a loss change rate between each pair of N−1 pairs of neighboring custom intervals within a designated window prior to a present custom interval; calculate, for each task, a gradient magnitude with respect to selected shared weights within the designated window prior to the present custom interval; and adjust, for each task, a weight of the task, based on the loss change rate between each pair of the N−1 pairs of neighboring custom intervals within the designated window prior to the present custom interval for the task, and the gradient magnitude with respect to selected shared weights within the designated window prior to the present custom interval for each task.

Example 2 includes the apparatus of Example 1, wherein the processor circuitry is further configured to calculate, for each task, an adjustment factor of the task, which changes along a total loss change rate within the designated window prior to the present custom interval for the task, and a reciprocal of a proportion of the gradient magnitude with respect to selected shared weights within the designated window prior to the present custom interval for the task to gradient magnitudes with respect to selected shared weights within the designated window prior to the present custom interval for all tasks; and adjust the weight of the task by the adjustment factor of the task.

Example 3 includes the apparatus of Example 2, wherein the processor circuitry is configured to adjust, for each task, the weight of the task, according to equations:

$${w}_{k} ( t ) := \frac{K exp ( {λ}_{k} ( t - 1 ) / T )}{{\sum }_{i = 1}^{K} ex [ ( {λ}_{i} ( t - 1 ) / T )}$$

$${\sum }_{i = 1}^{K} {w}_{k} ( t ) = K ,$$

where K denotes a total number of tasks, k=1, . . . , K denotes k^{th} task, wₖ(·) denotes a weight of k^{th} task, t denotes the present custom interval, λₖ(·) denotes the adjustment factor for k^{th} task, T is a scaling factor to control softness of task weighting, and a larger T results in a more even weight distribution among tasks.

Example 4 includes the apparatus of Example 2 or 3, wherein the processor circuitry is further configured to calculate, for each task, a decaying coefficient corresponding to the loss change rate between each pair of the N−1 pairs of neighboring custom intervals within the designated window prior to the present custom interval for the task, wherein the adjustment factor of the task changes along the total loss change rate weighted by corresponding decaying coefficients.

Example 5 includes the apparatus of Example 4, wherein for each task, a sum of decaying coefficients corresponding to loss change rates of the N−1 pairs of neighboring custom intervals within the designated window prior to the present custom interval equal one, and a decaying coefficient corresponding to a pair of neighboring custom intervals closer to the present custom interval is greater.

Example 6 includes the apparatus of Example 4, wherein the processor circuitry is further configured to calculate, for each task, the decaying coefficient, according to equations:

$${α}_{n} = {\int }_{n - 1}^{n} f ( x ) dx , n = 1 , … , N - 1.$$

$$f ( x ) = - \frac{2}{{( N - 1 )}^{2}} x + \frac{2}{N - 1} , 0 \leq x \leq N - 1 ,$$

where t denotes the present custom interval, and an is the decaying coefficient between (t−n)^{th} interval and (t−(n+1))^{th} interval.

Example 7 includes the apparatus of Example 4, wherein the processor circuitry is configured to calculate, for each task, the adjustment factor of the task, according to an equation:

$${λ}_{k} ( t - 1 ) = ( {\sum }_{j = 1}^{N - 1} {α}_{j} * \frac{{L}_{k} ( t - j )}{{L}_{k} ( t - j - 1 )} ) * {( log \frac{{\sum }_{i = 1}^{K} {\sum }_{j = 1}^{N} {G}_{i} ( t - j )}{{\sum }_{j = 1}^{N} {G}_{k} ( t - j )} )}^{scale\_exp}$$

where K denotes a total number of tasks, k=1, . . . , K denotes k^{th} task, wₖ(·) denotes a weight of k^{th} task, t denotes the present custom interval, λₖ(·) denotes the adjustment factor for k^{th} task, aⱼ denotes a decaying coefficient corresponding to a loss change rate between (t−j)^{th} custom interval and (t−(j+1))^{th} custom interval and Σⱼ₌₁^{N-1}aⱼ=1, j=1, . . . , N−1, Lₖ(·) denotes an average loss in a custom interval of k^{th} task, Gₖ (·) denotes a gradient magnitude with respect to the selected shared weights of k^{th} task, and scale_exp is a scaling factor to control importance of each gradient magnitude to accommodate for various priors between tasks.

Example 8 includes the apparatus of any of Examples 1 to 7, wherein the interface circuitry is further configured to record, during each mini-batch training step, a task loss and a task gradient with respect to selected shared weights for each task, wherein a loss and a gradient magnitude with respect to selected shared weights within a custom interval for each task are an average of task losses and task gradients with respect to selected shared weights for the task recorded during the designated number of mini-batch training steps within the custom interval.

Example 9 includes the apparatus of any of Examples 1 to 8, wherein selected shared weights are weights of a last shared layer of the deep neural network for MTL.

Example 10 includes the apparatus of any of Examples 1 to 9, the pre-trained neural network comprises pre-trained models for computer vision, natural language understanding, or vision and language learning.

Example 11 includes the apparatus of any of Examples 1 to 10, wherein the deep neural network for MTL is initialized with Bidirectional Encoder Representations from Transformers (BERT).

Example 12 includes the apparatus of any of Examples 1 to 11, wherein a gradient magnitude with respect to selected shared weights is expressed by a Euclidean norm of a gradient of a weighted task-specific loss with respect to the selected shared weights.

Example 13 includes a method for loss balancing in multi-task learning (MTL), comprising: initializing parameters of shared layers of a deep neural network for MTL using a pre-trained neural network; determining a custom interval consisting of a designated number of mini-batch training steps and a designated window of N custom intervals, wherein N is an integer greater than 1; calculating, for each task, a loss change rate between each pair of N−1 pairs of neighboring custom intervals within a designated window prior to a present custom interval; calculating, for each task, a gradient magnitude with respect to selected shared weights within the designated window prior to the present custom interval; and adjusting, for each task, a weight of the task, based on the loss change rate between each pair of the N−1 pairs of neighboring custom intervals within the designated window prior to the present custom interval for the task, and the gradient magnitude with respect to selected shared weights within the designated window prior to the present custom interval for each task.

Example 14 includes the method of Example 13, further comprising: calculating, for each task, an adjustment factor of the task, which changes along a total loss change rate within the designated window prior to the present custom interval for the task, and a reciprocal of a proportion of the gradient magnitude with respect to selected shared weights within the designated window prior to the present custom interval for the task to gradient magnitudes with respect to selected shared weights within the designated window prior to the present custom interval for all tasks; and adjusting the weight of the task by the adjustment factor of the task.

Example 15 includes the method of Example 14, further comprising adjusting, for each task, the weight of the task, according to equations:

$${w}_{k} ( t ) := \frac{K exp ( {λ}_{k} ( t - 1 ) / T )}{{\sum }_{i = 1}^{K} exp ( {λ}_{i} ( t - 1 ) / T )} ,$$

$${\sum }_{i = 1}^{K} {w}_{k} ( t ) = K .$$

where K denotes a total number of tasks, k=1, . . . , K denotes k^{th} task, wₖ(·) denotes a weight of k^{th} task, t denotes the present custom interval, λₖ(·) denotes the adjustment factor for k^{th} task, T is a scaling factor to control softness of task weighting, and a larger T results in a more even weight distribution among tasks.

Example 16 includes the method of Example 14 or 15, further comprising: calculating, for each task, a decaying coefficient corresponding to the loss change rate between each pair of the N−1 pairs of neighboring custom intervals within the designated window prior to the present custom interval for the task, wherein the adjustment factor of the task changes along the total loss change rate weighted by corresponding decaying coefficients.

Example 17 includes the method of Example 16, wherein for each task, a sum of decaying coefficients corresponding to loss change rates of the N−1 pairs of neighboring custom intervals within the designated window prior to the present custom interval equal one, and a decaying coefficient corresponding to a pair of neighboring custom intervals closer to the present custom interval is greater.

Example 18 includes the method of Example 16, comprising calculating, for each task, the decaying coefficient, according to equations:

$${α}_{n} = {\int }_{n - 1}^{n} f ( x ) dx , n = 1 , … , N - 1 ,$$

$$f ( x ) = - \frac{2}{{( N - 1 )}^{2}} x + \frac{2}{N - 1} , 0 \leq x \leq N - 1 ,$$

where t denotes the present custom interval, and an is the decaying coefficient between (t−n)^{th} interval and (t−(n+1))^{th} interval.

Example 19 includes the method of Example 16, comprising calculating, for each task, the adjustment factor of the task, according to an equation:

$${λ}_{k} ( t - 1 ) = ( {\sum }_{j = 1}^{N - 1} {α}_{j} * \frac{{L}_{k} ( t - j )}{{L}_{k} ( t - j - 1 )} ) * {( log \frac{{\sum }_{i = 1}^{K} {\sum }_{j = 1}^{N} {G}_{i} ( t - j )}{{\sum }_{j = 1}^{N} {G}_{k} ( t - j )} )}^{scale\_exp}$$

where K denotes a total number of tasks, k=1, . . . , K denotes k^{th} task, wₖ(·) denotes a weight of k^{th} task, t denotes the present custom interval, λₖ(·) denotes the adjustment factor for k^{th} task, aⱼ denotes a decaying coefficient corresponding to a loss change rate between (t−j)^{th} custom interval and (t−(j+1))^{th} custom interval and Σⱼ₌₁^{N-1}aⱼ=1,j=1, . . . , N−1, Lₖ(·) denotes an average loss in a custom interval of k^{th} task, Gₖ(·) denotes a gradient magnitude with respect to the selected shared weights of k^{th} task, and scale_exp is a scaling factor to control importance of each gradient magnitude to accommodate for various priors between tasks.

Example 20 includes the method of any of Examples 13 to 19, further comprising recording, during each mini-batch training step, a task loss and a task gradient with respect to selected shared weights for each task, wherein a loss and a gradient magnitude with respect to selected shared weights within a custom interval for each task are an average of task losses and task gradients with respect to selected shared weights for the task recorded during the designated number of mini-batch training steps within the custom interval.

Example 21 includes the method of any of Examples 13 to 20, wherein selected shared weights are weights of a last shared layer of the deep neural network for MTL.

Example 22 includes the method of any of Examples 13 to 21, wherein the pre-trained neural network comprises pre-trained models for computer vision, natural language understanding, or vision and language learning.

Example 23 includes the method of any of Examples 13 to 22, wherein the deep neural network for MTL is initialized with Bidirectional Encoder Representations from Transformers (BERT).

Example 24 includes the method of any of Examples 13 to 23, wherein a gradient magnitude with respect to selected shared weights is expressed by a Euclidean norm of a gradient of a weighted task-specific loss with respect to the selected shared weights.

Example 25 includes a machine readable storage medium, having instructions stored thereon, which when executed by a machine, cause the machine to perform operations for loss balancing in multi-task learning (MTL), comprising: initializing parameters of shared layers of a deep neural network for MTL using a pre-trained neural network; determining a custom interval consisting of a designated number of mini-batch training steps and a designated window of N custom intervals, wherein Nis an integer greater than 1; calculating, for each task, a loss change rate between each pair of N−1 pairs of neighboring custom intervals within a designated window prior to a present custom interval; calculating, for each task, a gradient magnitude with respect to selected shared weights within the designated window prior to the present custom interval; and adjusting, for each task, a weight of the task, based on the loss change rate between each pair of the N−1 pairs of neighboring custom intervals within the designated window prior to the present custom interval for the task, and the gradient magnitude with respect to selected shared weights within the designated window prior to the present custom interval for each task.

Example 26 includes the machine readable storage medium of Example 25, wherein the instructions, when executed by the machine, further cause the machine to calculate, for each task, an adjustment factor of the task, which changes along a total loss change rate within the designated window prior to the present custom interval for the task, and a reciprocal of a proportion of the gradient magnitude with respect to selected shared weights within the designated window prior to the present custom interval for the task to gradient magnitudes with respect to selected shared weights within the designated window prior to the present custom interval for all tasks; and adjust the weight of the task by the adjustment factor of the task.

Example 27 includes the machine readable storage medium of Example 26, wherein the instructions, when executed by the machine, further cause the machine to adjust, for each task, the weight of the task, according to equations:

$${w}_{k} ( t ) := \frac{K exp ( {λ}_{k} ( t - 1 ) / T )}{{\sum }_{i = 1}^{K} exp ( {λ}_{i} ( t - 1 ) / T )} ,$$

$${\sum }_{i = 1}^{K} {w}_{k} ( t ) = K ,$$

where K denotes a total number of tasks, k=1, . . . , K denotes k^{th} task, wₖ(·) denotes a weight of k^{th} task, t denotes the present custom interval, λₖ(·) denotes the adjustment factor for k^{th} task, T is a scaling factor to control softness of task weighting, and a larger T results in a more even weight distribution among tasks.

Example 28 includes the machine readable storage medium of Example 26 or 27, wherein the instructions, when executed by the machine, further cause the machine to calculate, for each task, a decaying coefficient corresponding to the loss change rate between each pair of the N−1 pairs of neighboring custom intervals within the designated window prior to the present custom interval for the task, wherein the adjustment factor of the task changes along the total loss change rate weighted by corresponding decaying coefficients.

Example 29 includes the machine readable storage medium of Example 28, wherein for each task, a sum of decaying coefficients corresponding to loss change rates of the N−1 pairs of neighboring custom intervals within the designated window prior to the present custom interval equal one, and a decaying coefficient corresponding to a pair of neighboring custom intervals closer to the present custom interval is greater.

Example 30 includes the machine readable storage medium of Example 28, wherein the instructions, when executed by the machine, further cause the machine to calculate, for each task, the decaying coefficient, according to equations:

$${α}_{n} = {\int }_{n - 1}^{n} f ( x ) dx , n = 1 , … , N - 1 ,$$

$$f ( x ) = - \frac{2}{{( N - 1 )}^{2}} x + \frac{2}{N - 1} , 0 \leq x \leq N - 1 ,$$

where t denotes the present custom interval, and an is the decaying coefficient between (t−n)^{th} interval and (t−(n+1))^{th} interval.

Example 31 includes the machine readable storage medium of Example 28, wherein the instructions, when executed by the machine, further cause the machine to calculate, for each task, the adjustment factor of the task, according to an equation:

$${λ}_{k} ( t - 1 ) = ( {\sum }_{j = 1}^{N - 1} {α}_{j} * \frac{{L}_{k} ( t - j )}{{L}_{k} ( t - j - 1 )} ) * {( log \frac{{\sum }_{i = 1}^{K} {\sum }_{j = 1}^{N} {G}_{i} ( t - j )}{{\sum }_{j = 1}^{N} {G}_{k} ( t - j )} )}^{scale\_exp}$$

where K denotes a total number of tasks, k=1, . . . , K denotes k^{th} task, wₖ(·) denotes a weight of k^{th} task, t denotes the present custom interval, λₖ(·) denotes the adjustment factor for k^{th} task, aⱼ denotes a decaying coefficient corresponding to a loss change rate between (t−j)^{th} custom interval and (t−(j+1))^{th} custom interval and Σⱼ₌₁^{N-1}aⱼ=1, j=1, . . . , N−1, Lₖ(·) denotes an average loss in a custom interval of k^{th} task, Gₖ (·) denotes a gradient magnitude with respect to the selected shared weights of k^{th} task, and scale_exp is a scaling factor to control importance of each gradient magnitude to accommodate for various priors between tasks.

Example 32 includes the machine readable storage medium of any of Examples 25 to 31, wherein the instructions, when executed by the machine, further cause the machine to record, during each mini-batch training step, a task loss and a task gradient with respect to selected shared weights for each task, wherein a loss and a gradient magnitude with respect to selected shared weights within a custom interval for each task are an average of task losses and task gradients with respect to selected shared weights for the task recorded during the designated number of mini-batch training steps within the custom interval.

Example 33 includes the machine readable storage medium of any of Examples 25 to 32, wherein selected shared weights are weights of a last shared layer of the deep neural network for MTL.

Example 34 includes the machine readable storage medium of any of Examples 25 to 33, wherein the pre-trained neural network comprises pre-trained models for computer vision, natural language understanding, or vision and language learning.

Example 35 includes the machine readable storage medium of any of Examples 25 to 34, wherein the deep neural network for MTL is initialized with Bidirectional Encoder Representations from Transformers (BERT).

Example 36 includes the machine readable storage medium of any of Examples 25 to 35, wherein a gradient magnitude with respect to selected shared weights is expressed by a Euclidean norm of a gradient of a weighted task-specific loss with respect to the selected shared weights.

Example 37 includes a device for loss balancing in multi-task learning (MTL), comprising: means for initializing parameters of shared layers of a deep neural network for MTL using a pre-trained neural network; means for determining a custom interval consisting of a designated number of mini-batch training steps and a designated window of N custom intervals, wherein N is an integer greater than 1; means for calculating, for each task, a loss change rate between each pair of N−1 pairs of neighboring custom intervals within a designated window prior to a present custom interval; means for calculating, for each task, a gradient magnitude with respect to selected shared weights within the designated window prior to the present custom interval; and means for adjusting, for each task, a weight of the task, based on the loss change rate between each pair of the N−1 pairs of neighboring custom intervals within the designated window prior to the present custom interval for the task, and the gradient magnitude with respect to selected shared weights within the designated window prior to the present custom interval for each task.

Example 38 includes the device of Example 37, further comprising: means for calculating, for each task, an adjustment factor of the task, which changes along a total loss change rate within the designated window prior to the present custom interval for the task, and a reciprocal of a proportion of the gradient magnitude with respect to selected shared weights within the designated window prior to the present custom interval for the task to gradient magnitudes with respect to selected shared weights within the designated window prior to the present custom interval for all tasks; and adjusting the weight of the task by the adjustment factor of the task.

Example 39 includes the device of Example 38, further comprising means for adjusting, for each task, the weight of the task, according to equations:

$${w}_{k} ( t ) := \frac{K exp ( {λ}_{k} ( t - 1 ) / T )}{{\sum }_{i = 1}^{K} exp ( {λ}_{i} ( t - 1 ) / T )} ,$$

$${\sum }_{i = 1}^{K} {w}_{k} ( t ) = K ,$$

where K denotes a total number of tasks, k=1, . . . , K denotes k^{th} task, Wₖ(·) denotes a weight of k^{th} task, t denotes the present custom interval, λₖ(·) denotes the adjustment factor for k^{th} task, T is a scaling factor to control softness of task weighting, and a larger T results in a more even weight distribution among tasks.

Example 40 includes the device of Example 38 or 39, further comprising: means for calculating, for each task, a decaying coefficient corresponding to the loss change rate between each pair of the N−1 pairs of neighboring custom intervals within the designated window prior to the present custom interval for the task, wherein the adjustment factor of the task changes along the total loss change rate weighted by corresponding decaying coefficients.

Example 41 includes the device of Example 40, wherein for each task, a sum of decaying coefficients corresponding to loss change rates of the N−1 pairs of neighboring custom intervals within the designated window prior to the present custom interval equal one, and a decaying coefficient corresponding to a pair of neighboring custom intervals closer to the present custom interval is greater.

Example 42 includes the device of Example 40, comprising means for calculating, for each task, the decaying coefficient, according to equations:

$${α}_{n} = {\int }_{n - 1}^{n} f ( x ) dx , n = 1 , … , N - 1 ,$$

$$f ( x ) = - \frac{2}{{( N - 1 )}^{2}} x + \frac{2}{N - 1} , 0 \leq x \leq N - 1 ,$$

where t denotes the present custom interval, and an is the decaying coefficient between (t−n)^{th} interval and (t−(n+1))^{th} interval.

Example 43 includes the device of Example 40, comprising means for calculating, for each task, the adjustment factor of the task, according to an equation:

$${λ}_{k} ( t - 1 ) = ( {\sum }_{j = 1}^{N - 1} {α}_{j} * \frac{{L}_{k} ( t - j )}{{L}_{k} ( t - j - 1 )} ) * {( log \frac{{\sum }_{i = 1}^{K} {\sum }_{j = 1}^{N} {G}_{i} ( t - j )}{{\sum }_{j = 1}^{N} {G}_{k} ( t - j )} )}^{scale\_exp}$$

where K denotes a total number of tasks, k=1, . . . , K denotes k^{th} task, wₖ(·) denotes a weight of k^{th} task, t denotes the present custom interval, λₖ(·) denotes the adjustment factor for k^{th} task, aⱼ denotes a decaying coefficient corresponding to a loss change rate between (t−j)^{th} custom interval and (t−(j+1))^{th} custom interval and Σⱼ₌₁^{N-1}aⱼ=1, j=1, . . . , N−1, Lₖ(·) denotes an average loss in a custom interval of k^{th} task, Gₖ (·) denotes a gradient magnitude with respect to the selected shared weights of k^{th} task, and scale_exp is a scaling factor to control importance of each gradient magnitude to accommodate for various priors between tasks.

Example 44 includes the device of any of Examples 37 to 43, further comprising means for recording, during each mini-batch training step, a task loss and a task gradient with respect to selected shared weights for each task, wherein a loss and a gradient magnitude with respect to selected shared weights within a custom interval for each task are an average of task losses and task gradients with respect to selected shared weights for the task recorded during the designated number of mini-batch training steps within the custom interval.

Example 45 includes the device of any of Examples 37 to 44, wherein selected shared weights are weights of a last shared layer of the deep neural network for MTL.

Example 46 includes the device of any of Examples 37 to 45, wherein the pre-trained neural network comprises pre-trained models for computer vision, natural language understanding, or vision and language learning.

Example 47 includes the device of any of Examples 37 to 46, wherein the deep neural network for MTL is initialized with Bidirectional Encoder Representations from Transformers (BERT).

Example 48 includes the device of any of Examples 37 to 47, wherein a gradient magnitude with respect to selected shared weights is expressed by a Euclidean norm of a gradient of a weighted task-specific loss with respect to the selected shared weights.

Example 49 includes a computer program product, having programs to perform the method of any of Examples 13 to 24.

Example 50 includes an apparatus as shown and described in the description.

Example 51 includes a method performed at an apparatus as shown and described in the description.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. The disclosure is intended to cover any adaptations or variations of the embodiments discussed herein. Therefore, it is manifestly intended that embodiments described herein be limited only by the appended claims and the equivalents thereof.

1. An apparatus for loss balancing in multi-task learning (MTL), comprising:
interface circuitry to receive a pre-trained neural network;
instructions; and
processor circuitry to execute the instructions to:
initialize parameters of shared layers of a deep neural network for MTL using the pre-trained neural network;
determine a custom interval including a designated number of mini-batch training operations and a designated window of N custom intervals, wherein N is an integer greater than 1;
calculate, for each task, a loss change rate between each pair of N−1 pairs of neighboring custom intervals within a designated window prior to a present custom interval;
calculate, for each task, a gradient magnitude with respect to selected shared weights within the designated window prior to the present custom interval; and
adjust, for each task, a weight of the task, based on the loss change rate between each pair of the N−1 pairs of neighboring custom intervals within the designated window prior to the present custom interval for the task, and the gradient magnitude with respect to selected shared weights within the designated window prior to the present custom interval for each task.

2. The apparatus of claim 1, wherein the processor circuitry is to
calculate, for each task, an adjustment factor of the task, which changes along a total loss change rate within the designated window prior to the present custom interval for the task, and a reciprocal of a proportion of the gradient magnitude with respect to selected shared weights within the designated window prior to the present custom interval for the task to gradient magnitudes with respect to selected shared weights within the designated window prior to the present custom interval for all tasks; and
adjust the weight of the task by the adjustment factor of the task.

3. The apparatus of claim 2, wherein the processor circuitry is to adjust, for each task, the weight of the task, according to equations:
$${w}_{k} ( t ) := \frac{K exp ( {λ}_{k} ( t - 1 ) / T )}{{\sum }_{i = 1}^{K} exp ( {λ}_{i} ( t - 1 ) / T )} ,$$
$${\sum }_{i = 1}^{K} {w}_{k} ( t ) = K ,$$
where K denotes a total number of tasks, k=1, . . . , K denotes k^{th} task, Wₖ(·) denotes a weight of k^{th} task, t denotes the present custom interval, λₖ(·) denotes the adjustment factor for k^{th} task, T is a scaling factor to control softness of task weighting, and a larger T results in a more even weight distribution among tasks.

4. The apparatus of claim 2, wherein the processor circuitry is to
calculate, for each task, a decaying coefficient corresponding to the loss change rate between each pair of the N−1 pairs of neighboring custom intervals within the designated window prior to the present custom interval for the task, wherein the adjustment factor of the task changes along the total loss change rate weighted by corresponding decaying coefficients.

5. The apparatus of claim 4, wherein for each task, a sum of decaying coefficients corresponding to loss change rates of the N−1 pairs of neighboring custom intervals within the designated window prior to the present custom interval equal one, and a decaying coefficient corresponding to a pair of neighboring custom intervals closer to the present custom interval is greater.

6. The apparatus of claim 4, wherein the processor circuitry is to calculate, for each task, the decaying coefficient, according to equations:
$${α}_{n} = {\int }_{n - 1}^{n} f ( x ) dx , n = 1 , … , N - 1 ,$$
$$f ( x ) = - \frac{2}{{( N - 1 )}^{2}} x + \frac{2}{N - 1} , 0 \leq x \leq N - 1 ,$$
where t denotes the present custom interval, and αₙ is the decaying coefficient between (t−n)^{th} interval and (t−(n+1))^{th} interval.

7. The apparatus of claim 4, wherein the processor circuitry is to calculate, for each task, the adjustment factor of the task, according to an equation:
$${λ}_{k} ( t - 1 ) = ( {\sum }_{j = 1}^{N - 1} {α}_{j} * \frac{{L}_{k} ( t - j )}{{L}_{k} ( t - j - 1 )} ) * {( log \frac{{\sum }_{i = 1}^{K} {\sum }_{j = 1}^{N} {G}_{i} ( t - j )}{{\sum }_{j = 1}^{N} {G}_{k} ( t - j )} )}^{scale\_exp} ,$$
where K denotes a total number of tasks, k=1, . . . , K denotes k^{th} task, wₖ (·) denotes a weight of k^{th} task, t denotes the present custom interval, λₖ(·) denotes the adjustment factor for k^{th} task, aⱼ denotes a decaying coefficient corresponding to a loss change rate between (t−j)^{th} custom interval and (t−(j+1))^{th} custom interval and Σⱼ₌₁^{N-1}aⱼ=1, j=1, . . . , N−1, Lₖ(·) denotes an average loss in a custom interval of k^{th} task, Gₖ(·) denotes a gradient magnitude with respect to the selected shared weights of k^{th} task, and scale_exp is a scaling factor to control importance of each gradient magnitude to accommodate for various priors between tasks.

8. The apparatus of claim 1, wherein the interface circuitry is to record, during each mini-batch training operation, a task loss and a task gradient with respect to selected shared weights for each task, wherein a loss and a gradient magnitude with respect to selected shared weights within a custom interval for each task are an average of task losses and task gradients with respect to selected shared weights for the task recorded during the designated number of mini-batch training operations within the custom interval.

9. The apparatus of claim 1, wherein the selected shared weights are weights of a last shared layer of the deep neural network for MTL.

10. The apparatus of claim 1, wherein the pre-trained neural network comprises pre-trained models for computer vision, natural language understanding, or vision and language learning.

11. The apparatus of claim 1, wherein the deep neural network for MTL is initialized with Bidirectional Encoder Representations from Transformers (BERT).

12. The apparatus of claim 1, wherein a gradient magnitude with respect to the selected shared weights is expressed by a Euclidean norm of a gradient of a weighted task-specific loss with respect to the selected shared weights.

13. A method for loss balancing in multi-task learning (MTL), comprising:
initializing parameters of shared layers of a deep neural network for MTL using a pre-trained neural network;
determining a custom interval including a designated number of mini-batch training operations and a designated window of N custom intervals, wherein Nis an integer greater than 1;
calculating, for each task, a loss change rate between each pair of N−1 pairs of neighboring custom intervals within a designated window prior to a present custom interval;
calculating, for each task, a gradient magnitude with respect to selected shared weights within the designated window prior to the present custom interval; and
adjusting, for each task, a weight of the task, based on the loss change rate between each pair of the N−1 pairs of neighboring custom intervals within the designated window prior to the present custom interval for the task, and the gradient magnitude with respect to selected shared weights within the designated window prior to the present custom interval for each task.

14. The method of claim 13, further comprising:
calculating, for each task, an adjustment factor of the task, which changes along a total loss change rate within the designated window prior to the present custom interval for the task, and a reciprocal of a proportion of the gradient magnitude with respect to selected shared weights within the designated window prior to the present custom interval for the task to gradient magnitudes with respect to selected shared weights within the designated window prior to the present custom interval for all tasks; and
adjusting the weight of the task by the adjustment factor of the task.

15. The method of claim 14, further comprising adjusting, for each task, the weight of the task, according to equations:
$${w}_{k} ( t ) := \frac{K exp ( {λ}_{k} ( t - 1 ) / T )}{{\sum }_{i = 1}^{K} exp ( {λ}_{i} ( t - 1 ) / T )} ,$$
$${\sum }_{i = 1}^{K} {w}_{k} ( t ) = K ,$$
where K denotes a total number of tasks, k=1, . . . , K denotes k^{th} task, wₖ (·) denotes a weight of k^{th} task, t denotes the present custom interval, λₖ(·) denotes the adjustment factor for k^{th} task, T is a scaling factor to control softness of task weighting, and a larger T results in a more even weight distribution among tasks.

16. The method of claim 14, further comprising:
calculating, for each task, a decaying coefficient corresponding to the loss change rate between each pair of the N−1 pairs of neighboring custom intervals within the designated window prior to the present custom interval for the task, wherein the adjustment factor of the task changes along the total loss change rate weighted by corresponding decaying coefficients.

17. The method of claim 16, wherein for each task, a sum of decaying coefficients corresponding to loss change rates of the N−1 pairs of neighboring custom intervals within the designated window prior to the present custom interval equal one, and a decaying coefficient corresponding to a pair of neighboring custom intervals closer to the present custom interval is greater.

18. The method of claim 16, comprising calculating, for each task, the decaying coefficient, according to equations:
$${α}_{n} = {\int }_{n - 1}^{n} f ( x ) dx , n = 1 , … , N - 1 ,$$
$$f ( x ) = - \frac{2}{{( N - 1 )}^{2}} x + \frac{2}{N - 1} , 0 \leq x \leq N - 1 ,$$
where t denotes the present custom interval, and an is the decaying coefficient between (t−n)^{th} interval and (t−(n+1))^{th} interval.

19. The method of claim 16, comprising calculating, for each task, the adjustment factor of the task, according to an equation:
$${λ}_{k} ( t - 1 ) = ( {\sum }_{j = 1}^{N - 1} {α}_{j} * \frac{{L}_{k} ( t - j )}{{L}_{k} ( t - j - 1 )} ) * {( log \frac{{\sum }_{i = 1}^{K} {\sum }_{j = 1}^{N} {G}_{i} ( t - j )}{{\sum }_{j = 1}^{N} {G}_{k} ( t - j )} )}^{scale\_exp} ,$$
where K denotes a total number of tasks, k=1, . . . , K denotes k^{th} task, Wₖ(·) denotes a weight of k^{th} task, t denotes the present custom interval, λₖ(·) denotes the adjustment factor for k^{th} task, aⱼ denotes a decaying coefficient corresponding to a loss change rate between (t−j)^{th} custom interval and (t−(j+1))^{th} custom interval and Σⱼ₌₁^{N-1}aⱼ=1,j, . . . , N−1, Lₖ(·) denotes an average loss in a custom interval of k^{th} task, Gₖ(·) denotes a gradient magnitude with respect to the selected shared weights of k^{th} task, and scale_exp is a scaling factor to control importance of each gradient magnitude to accommodate for various priors between tasks.

20. (canceled)

21. (canceled)

22. (canceled)

23. (canceled)

24. (canceled)

25. (canceled)

26. A memory comprising instructions to cause one or more machines to:
initialize parameters of shared layers of a deep neural network for loss balancing in multi-task learning (MTL) via a pre-trained neural network;
determine a custom interval including a designated number of mini-batch training operations and a designated window of N custom intervals, wherein Nis an integer greater than 1;
calculating, for respective tasks, a corresponding loss change rate between N−1 pairs of neighboring custom intervals within a designated window prior to a present custom interval;
calculating, for respective tasks, a gradient magnitude with respect to shared weights within the designated window prior to the present custom interval; and
adjusting, for respective tasks, a corresponding weight of the task, based on the loss change rate between the N−1 pairs of neighboring custom intervals within the designated window prior to the present custom interval for the task, and the gradient magnitude with respect to the shared weights within the designated window prior to the present custom interval for the corresponding task.
